(19) United States
(12) Patent Application Publication
(10) Pub. No.: US 2010/0263778 A1
(43) Pub. Date: Oct. 21, 2010

(54) Pneumatic Object Provided with a Gas-Impermeable Layer Based on a Thermoplastic Elastomer and a Platy Filler

(75) Inventors: Pierre Lesage, Clermont-Ferrand (FR); Emmanuel Custodero, Chamalieres (FR)

Correspondence Address: COHEN, PONTANI, LIEBERMAN & PAVANE LLP, 551 FIFTH AVENUE, SUITE 1210, NEW YORK, NY, 10176, US

(73) Assignees: Societe De Technologie Michelin, Clemont-Ferrand (FR); Michelin Recherche et Technique S.A., Granges-Paccot (CH)

(21) Appl. No.: 12/668,598

(22) PCT Filed: Jul. 4, 2008
(86) PCT No.: PCT/EP08/05479

§ 371 Date: Jun. 26, 2010

(30) Foreign Application Priority Data
Jul. 11, 2007 (FR) 07/05000

(51) Int. Cl. B60C 5/02; B32B 1/08; B60C 5/14

(52) U.S. Cl. 152/511; 428/36.6; 152/510

(57) ABSTRACT

Inflatable article equipped with a layer impermeable to the inflation gases, of improved hysteresis and impermeability. The layer comprises an elastomer composition comprising at least, as the sole elastomer or as the predominant elastomer by weight, a thermoplastic stirene elastomer (“TPS”) and a platy filler having a volume content greater than 5%. According to one preferred embodiment, the TPS elastomer is a copolymer with polystirene and polyisobutylene blocks such as SIBS (stirene/isobutylene/stirene) and the composition also comprises an extender oil for the elastomer, in particular a PIB (polyisobutylene) oil. The platy filler is especially chosen from graphites and phyllosilicates such as micas, clays or talcs. The inflatable article can be an inner tube or a pneumatic tire for a motor vehicle.

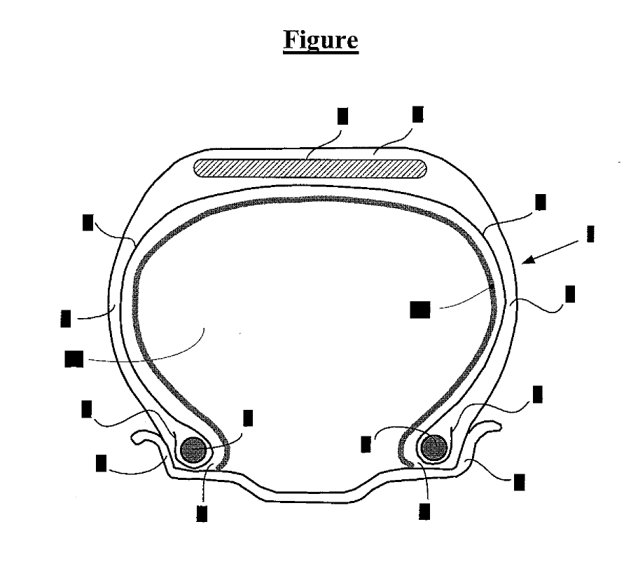

The present invention relates to “inflatable” articles, that is to say, by definition, to articles that assume their useable shape when they are inflated with air or with an equivalent inflation gas.

It relates more particularly to the gastight layers that ensure the impermeability of these inflatable articles, in particular that of pneumatic tires.

In a conventional pneumatic tire of the “tubeless” type (that is to say of the type without an inner tube), the radially internal face comprises an airtight layer (or more generally a layer that is impermeable to any inflation gas) which enables the pneumatic tire to be inflated and kept under pressure. Its airtightness properties enable it to guarantee a relatively low rate of pressure loss, making it possible to keep the tire inflated, in the normal operating state, for a sufficient time, normally several weeks or several months. It also has the role of protecting the carcass reinforcement and more generally the rest of the tire from a risk of oxidation due to the diffusion of air coming from the internal space of the tire.

This role of airtight inner layer or “inner liner” is today fulfilled by compositions based on butyl rubber (isobutylene/isoprene copolymer), long renowned for their excellent airtightness properties.

However, one well-known drawback of compositions based on butyl rubber or elastomer is that they have high hysteresis losses, furthermore over a wide temperature range, which drawback degrades the rolling resistance of pneumatic tires.

Reducing the hysteresis of these airtightness inner layers and therefore, in fine, the fuel consumption of motor vehicles, is a general objective which current technology comes up against.

However, the Applicants discovered, during their research, that an elastomer composition other than a butyl composition makes it possible to obtain sealing inner layers that respond to such an objective, while guaranteeing that the latter have excellent airtightness properties.

Thus, according to a first object, the present invention relates to an inflatable article equipped with a layer impermeable to inflation gases, characterized in that said layer comprises an elastomer composition comprising at least, as the sole elastomer or as the predominant elastomer by weight, a thermoplastic stirene (TPS) elastomer and a platy filler having a volume content of greater than 5% (% by volume of the composition).

Compared with a butyl rubber, the TPS elastomer has the major advantage, due to its thermoplastic nature, of being able to be worked as is in the molten (liquid) state, and consequently of offering a possibility of simplified processing; it has also proved compatible with the use of a platy filler in particularly high amounts, which makes it possible to further improve the airtightness compared with the solutions known from the prior art based on butyl rubber.

Preferably, the elastomer composition also comprises an extender oil for the TPS elastomer, which improves the integration of the elastomer layer in the inflatable article, via a lowering of the modulus and an increase in the tackifying power of the latter.

The invention particularly relates to inflatable articles made of rubber such as pneumatic tires, or inner tubes, especially inner tubes for a pneumatic tire.

The invention relates more particularly to the pneumatic tires intended to be fitted on motor vehicles of the passenger type, SUV (Sport Utility Vehicle) type, two-wheeled vehicles (especially motorcycles), aircraft, industrial vehicles chosen from vans, heavy vehicles—that is to say underground trains, buses, road transport vehicles (lorries, towing vehicles, trailers), off-road vehicles, such as agricultural and civil-engineering vehicles—and other transport or handling vehicles.

The invention also relates to a process for sealing an inflatable article with respect to inflation gases, in which a gastight layer as defined above is incorporated into said inflatable article during its manufacture or is added to said inflatable article after its manufacture.

The invention also relates to the use, in an inflatable article, of an elastomer composition as defined above as a layer impermeable to inflation gases.

The invention and its advantages will be easily understood in light of the description and of the exemplary embodiments that follow, and also from the single FIGURE relating to these examples which schematically shows, in radial cross section, a pneumatic tire according to the invention.

### I. DETAILED DESCRIPTION OF THE INVENTION

In the present description, unless otherwise indicated, all the percentages (%) indicated are % by weight.

Moreover, any range of values denoted by the expression “between a and b” represent the field of values ranging from more than a to less than b (that is to say limits a and b excluded) whereas any range of values denoted by the expression “from a to b” means the field of values ranging from a up to b (that is say including the strict limits a and b).

### I-1. Gastight Elastomer Composition

The inflatable article according to the invention has the main feature of being equipped with a layer that is impermeable to inflation gases that comprises an elastomer composition comprising at least, as the sole elastomer or as the predominant elastomer by weight present in said composition, a thermoplastic stirene elastomer, combined with which is a platy filler having a volume content of greater than 5%, and optionally an extender oil for said elastomer.

### I-1-A. Thermoplastic Stirene (TPS) Elastomer

The thermoplastic stirene (TPS) elastomers belong, in a known manner, to the family of thermoplastic elastomers (TPEs). Having a structure intermediate between thermoplastic polymers and elastomers, they are composed of hard polystirene blocks linked by flexible elastomer blocks, for example polybutadiene, polyisoprene, poly(ethylene-butylene) or else polyisobutylene blocks. They are often triblock elastomers with two hard segments linked by a flexible segment. The hard and flexible segments may be in a linear, star or branched configuration. Typically, each of these segments or blocks contains at least more than 5, generally more than 10 base units (for example stirene units and isoprene units for a stirene/isoprene/stirene block copolymer).

The TPS elastomer may be chosen, in particular, from the group consisting of stirene/butadiene/stirene block copolymers, stirene/isoprene/stirene block copolymers, stirene/isobutylene/stirene block copolymers, stirene/isoprene/butadiene/stirene block copolymers, stirene/ethylene-butylene/stirene block copolymers, stirene/ethylene-propylene/stirene block copolymers, stirene/ethylene-ethylene-propylene/stirene block copolymers and mixtures of these copolymers.

Preferably, the TPS elastomer is a copolymer with polystirene and polyisobutylene blocks. Such a definition should be understood as meaning any thermoplastic copolymer comprising at least one polystirene block (that is say one or more polystirene blocks) and at least one polyisobutylene block (that is to say one or more polyisobutylene blocks), with which other blocks (for example polyethylene and/or polypropylene blocks) and/or other monomer units (for example unsaturated units such as diene units) may or may not be combined.

More preferably still, such a block copolymer is a stirene/isobutylene/stirene (SIBS) triblock copolymer. The expression “SIBS elastomer or copolymer” is understood in the present application to mean, by definition, any stirene/isobutylene/stirene triblock elastomer in which the central polyisobutylene block can be interrupted or not by one or more unsaturated units, in particular one or more diene units such as isoprene units, which are optionally halogenated.

According to one preferred embodiment of the invention, the weight content of stirene in the TPS elastomer is between 5% and 50%. Below the minimum indicated, the thermoplastic nature of the elastomer runs the risk of being substantially reduced, whereas above the recommended maximum the elasticity of the airtight layer may be adversely affected. For these reasons, the stirene content is more preferably between 10% and 40%, in particular between 15 and 35%.

The term “stirene” should be understood in the present description as meaning any monomer based on unsubstituted or substituted stirene; among the substituted stirenes mention may be made, for example, of methylstirenes (for example, α-methylstirene, β-methylstirene, p-methylstirene, tert-butylstirene), chlorostirenes (for example monochlorostirene, dichlorostirene).

It is preferable for the glass transition temperature (T_{g}, measured according to ASTM D3418) of the TPS elastomer to be below −20° C., more preferably below −40° C. A T_{g} value above these minimum temperatures may reduce the performance of the airtight layer when used at a very low temperature; for such a use, the T_{g} of the TPS elastomer is more preferably still below −50° C.

The number-average molecular weight (denoted by Mₙ) of the TPS elastomer is preferably between 30 000 and 500 000 g/mol, more preferably between 40 000 and 400 000 g/mol. Below the minimum values indicated, the cohesion between the elastomer chains especially due to the optional dilution of the latter via an extender oil, runs the risk of being adversely affected; moreover, an increase in the usage temperature runs the risk of adversely affecting the mechanical properties, especially the properties at break, consequently leading to reduced “hot” performance. Moreover, too high a molecular weight Mₙ may be detrimental as regards the flexibility of the gastight layer. Thus, it has been observed that a value lying within a range of 50 000 to 300 000 g/mol was particularly suitable, especially for use of the composition in a pneumatic tire.

The number-average molecular weight (Mₙ) of the TPS elastomer is determined in a known manner by size exclusion chromatography (SEC). The specimen is first dissolved in tetrahydrofuran with a concentration of about 1 g/l; then the solution is filtered on a filter of 0.45 μm porosity before injection. The apparatus used is a WATERS Alliance chromatograph. The elution solvent is tetrahydrofuran, the flow rate is 0.7 ml/min, the temperature of the system is 35° C. and the analysis time is 90 min. A set of four WATERS columns in series having the trade names STYRAGEL (HMW7, HMW6E and two HT6E) is used. The injected volume of the polymer specimen solution is 100 μl. The detector is a WATERS 2410 differential refractometer and its associated software for handling the chromatographic data is the WATERS MILLENNIUM system. The calculated average molecular weights are relative to a calibration curve obtained with polystirene standards.

The polydispersity index Iₚ (N.B: Iₚ=M_{w}/Mₙ where M_{w} is the weight-average molecular weight) of the TPS elastomer is preferably less than 3, more preferably Iₚ is less than 2.

The TPS elastomer and the platy filler may, on their own, constitute the gastight elastomer layer or else be combined, in the elastomer composition, with other elastomers.

If optional other elastomers are used in the composition, the TPS elastomer constitutes the predominant elastomer by weight; it then preferably represents more than 50%, more preferably more than 70% by weight of all of the elastomers present in the elastomer composition. Such additional elastomers, which are the minority by weight, could be for example diene elastomers such as natural rubber or a synthetic polyisoprene, a butyl rubber or thermoplastic elastomers other than thermoplastic stirene elastomers, within the limit of the compatibility of their microstructures.

However, according to one preferred embodiment, the TPS, in particular SIBS, elastomer is the sole elastomer, and the sole thermoplastic elastomer present in the elastomer composition of the gastight layer.

The TPS elastomers may be processed in a conventional manner for TPEs, by extrusion or moulding, for example starting from a raw material available in the form of beads or granules.

The TPS elastomers are available commercially, sold for example as regards the SIBS by KANEKA under the name “SIBSTAR” (e.g. “Sibstar 102T”, “Sibstar 103T” or “Sibstar 073T”). They have for example been described, and also their synthesis, in patent documents EP 731 112, U.S. Pat. No. 4,946,899 and U.S. Pat. No. 5,260,383. They were firstly developed for biomedical applications then described in various applications specific to TPE elastomers, as varied as medical equipment, motor vehicle parts or parts for electrical goods, sheaths for electrical wires, sealing or elastic parts (see, for example, EP 1 431 343, EP 1 561 783, EP 1 566 405 and WO 2005/103146).

However, to the knowledge of the Applicants no prior art document either describes nor suggests the use, in an inflatable article such as in particular a pneumatic tire, of an elastomer composition comprising in combination a TPS elastomer such as SIBS and more than 5% by volume of platy filler, which composition has proved, quite unexpectedly, capable of competing with conventional compositions based on butyl rubber.

### I-1-B. Platy Filler

The use of a platy filler, having a volume content which may be particularly high as it is preferably between 5% and 50%, advantageously makes it possible to reduce the permeability coefficient (therefore to increase the airtightness) of the elastomer composition without excessively increasing its modulus, which makes it possible to retain the ease of integrating the airtight layer into the inflatable article.

Fillers referred to as platy fillers are well known to a person skilled in the art. They have been used, in particular, in pneumatic tires for reducing the permeability of conventional gastight layers based on butyl rubber. In these layers based on butyl rubber, they are generally used at relatively low contents, which do not usually exceed 10 to 15 phr (see, for example, patent documents US 2004/0194863, WO 2006/047509).

They are generally in the form of stacked plates, platelets, sheets or foliates with a relatively pronounced anisometry. Their aspect ratio (F=LIE) is generally greater than 3, more often greater than 5 or than 10. L represents the length (or larger dimension) and E the average thickness of these platy fillers, these averages being calculated by number. Aspect ratios reaching several tens or even hundreds are frequent. Their average length is preferably greater that 1 μm (that is to say that they are then platy fillers known as micron-scale platy fillers), typically between a few μm (for example 5 μm) and a few hundred μm (for example 500 or even 800 μm).

Preferably, the platy fillers used in accordance with the invention are chosen from the group consisting of graphites, phyllosilicates and mixtures of such fillers. Among the phyllosilicates, mention will especially be made of clays, talcs, micas, kaolins, these phyllosilicates possibly being modified or not for example by a surface treatment; as examples of such modified phyllosilicates, mention may especially be made of micas covered with titanium oxide, and clays modified by surfactants (“organoclays”).

Use is preferably made of platy fillers having a low surface energy, that is to say that are relatively apolar, such as those chosen from the group consisting of graphites, talcs, micas and mixtures of such fillers, the latter possibly being modified or not, more preferably still from the group consisting of graphites, talcs and mixtures of such fillers. Among the graphites mention may especially be made of natural graphites, expanded graphites or synthetic graphites.

As examples of micas, mention may be made of the micas sold by CMMP (Mica-MU®, Mica-Soft®, Briomica® for example), vermiculites (especially the Shawatec® vermiculite sold by CMMP or the Microlite® vermiculite sold by W.R. Grace), modified or treated micas (for example, the Iriodin® range sold by Merck). As examples of graphites, mention may be made of the graphites sold by Timcal (Timrex® range). As examples of talcs, mention may be made of the talcs sold by Luzenac.

The platy fillers described above are used at a high content, greater than 5%, preferably at least equal to 10% by volume of elastomer composition. Such a volume content typically corresponds, taking into account the average density of the platy fillers used (typically between 2.0 and 3.0) and that of the TPS elastomers used, to a weight content greater than 20 phr, preferably at least equal to 40 phr.

In order to further increase the airtightness of the TPS elastomer layer, it is possible to use a still higher content of platy filler, at least equal to 15% or even 20% by volume, which typically corresponds to weight contents at least equal to 50 phr or even 80 phr. Weight contents greater than 100 phr are even advantageously possible.

The platy filler content is however preferably less than 50% by volume (typically less than 500 phr), the upper limit starting from which problems of increase in the modulus, embrittlement of the composition, difficulties in dispersing the filler and in processing, not to mention a possible degradation of the hysteresis, may be encountered.

The introduction of platy fillers into the thermoplastic elastomer composition may be carried out according to various known processes, for example by compounding in solution, by bulk compounding in an internal mixer, or else by compounding via extrusion.

### I-1-C. Extender Oil

The TPS elastomer and the platy filler are sufficient by themselves for the function of impermeability to gases with respect to the inflatable articles in which they are used to be fulfilled.

However, according to one preferred embodiment of the invention, the elastomer composition described previously also comprises, as a plasticizing agent, an extender oil (or plasticizing oil), the role of which is to facilitate the processing of the gastight layer, particularly its integration into the inflatable article via a lowering of the modulus and an increase in the tackifying power.

Any extender oil may be used, preferably one having a weakly polar character, capable of extending or plasticizing elastomers, especially thermoplastic elastomers. At ambient temperature (23° C.), these oils, which are relatively viscous, are liquids (i.e. as a reminder, substances having the capability of eventually taking the form of their container), as opposed especially to resins, particularly to tackifying resins, which are by nature solids.

Preferably, the extender oil is chosen from the group consisting of polyolefin oils (i.e. those resulting from the polymerization of olefins, monoolefins or diolefins), paraffinic oils, naphthenic oils (of low or high viscosity), aromatic oils, mineral oils and mixtures of these oils.

Although it has been observed that the addition of oil was indeed carried out at the expense of a certain loss of impermeability, which varies depending on the type and amount of oil used, this loss of impermeability may be largely corrected by adjusting the platy filler content.

Preferably, a polybutene oil, in particular a polyisobutylene (PIB) oil, is used, which demonstrated the best compromise of properties compared with the other oils tested, especially compared with a conventional oil of paraffinic type.

Examples of polyisobutylene oils include those sold in particular by Univar under the trade name “Dynapak Poly” (e.g. “Dynapak Poly 190”), by BASF under the trade names “Glissopal” (e.g. “Glissopal 1000”) or “Oppanol” (e.g. “Oppanol B12”); paraffinic oils are sold for example by Exxon under the trade name “Telura 618” or by Repsol under the trade name “Extensol 51”.

The number-average molecular weight (Mₙ) of the extender oil is preferably between 200 and 25 000 g/mol, more preferably still between 300 and 10 000 g/mol. For excessively low Mₙ values, there is a risk of the oil migrating to the outside of the composition, whereas excessively high Mₙ, values may result in this composition becoming too stiff. An Mₙ value between 350 and 4000 g/mol, in particular between 400 and 3000 g/mol, proves to be an excellent compromise for the intended applications, in particular for use in a pneumatic tire.

The number-average molecular weight (Mₙ) of the extender oil is determined by SEC, the specimen being firstly dissolved in tetrahydrofuran with a concentration of about 1 g/l and then the solution is filtered on a filter of 0.45 μm porosity before injection. The apparatus is the WATERS Alliance chromatograph. The elution solvent is tetrahydrofuran, the flow rate is 1 ml/min, the temperature of the system is 35° C. and the analysis time is 30 min. A set of two WATERS columns with the trade name “STYRAGEL HT6E” is used. The injected volume of the polymer specimen solution is 100 μl. The detector is a WATERS 2410 differential refractometer and its associated software for handling the chromatograph data is the WATERS MILLENIUM system. The calculated average molecular weights are relative to a calibration curve obtained with polystirene standards.

A person skilled in the art will know, in the light of the description and the embodiments that follow, how to adjust the quantity of extender oil according to the particular usage conditions of the gastight elastomer layer, in particular of the inflatable article in which it is intended to be used.

It is preferable for the extender oil content to be greater than 5 phr, preferably between 5 and 100 phr (parts by weight per hundred parts of total elastomer, that is to say TPS elastomer plus any other possible elastomer present in the elastomer composition or layer).

Below the indicated minimum, the elastomer composition runs the risk of having too high a rigidity for certain applications, whereas above the recommended maximum there is a risk of the composition having insufficient cohesion and of a loss of impermeability which may be damaging depending on the application in question.

For these reasons, in particular for use of the airtight composition in a pneumatic tire, the extender oil content is preferably greater than 10 phr, especially between 10 and 90 phr, more preferably still is greater than 20 phr, especially between 20 and 80 phr.

### 1-1-D. Various Additives

The airtight layer or composition described previously may furthermore comprise the various additives usually present in the airtight layers known to a person skilled in the art. Mention will be made, for example, of reinforcing fillers such as carbon black or silica, non-reinforcing or inert fillers other than the platy fillers described previously, colorants that can advantageously be used for colouring the composition, plasticizers other than the aforementioned extender oils, tackifying resins, stabilizers such as antioxidants or antiozonants, UV stabilizers, various processing aids or other stabilizers, or else promoters capable of promoting adhesion to the remainder of the structure of the inflatable article.

Besides the elastomers (TPS elastomer and other possible elastomers) described previously, the gastight composition could also comprise, always in a minority weight fraction relative to the TPS elastomer, polymers other than elastomers, such as for example thermoplastic polymers compatible with the TPS elastomer.

The gastight layer or composition described previously is a compound that is solid (at 23° C.) and elastic, which is especially characterized, thanks to its specific formulation, by a very high flexibility and very high deformability.

According to one preferred embodiment of the invention, this gastight layer or composition has a secant extension modulus, at 10% elongation (denoted by M10), which is less than 2 MPa, more preferably less than 1.5 MPa (especially less than 1 MPa). This quantity is measured at first elongation (that is to say without an accommodation cycle) at a temperature of 23° C., with a pull rate of 500 mm/min (ASTM D412 standard), and normalized to the initial cross section of the test specimen.

### 1-2. Use of the Airtight Layer in a Pneumatic Tire

The composition based on a TPS elastomer described previously can be used as an airtight layer in any type of inflatable article. As examples of such inflatable articles, mention may be made of inflatable boats, balloons or balls used for games or sports.

Said composition is particularly suitable for use as an airtight layer (or a layer that is impermeable to any other inflation gas, for example nitrogen) in an inflatable article, whether a finished or semi-finished product, made of rubber, most particularly in a pneumatic tire for a motor vehicle such as a two-wheeled, passenger or industrial vehicle.

Such an airtight layer is preferably placed on the inner wall of the inflatable article, but it may also be completely integrated into its internal structure.

The thickness of the airtight layer is preferably greater than 0.05 mm, more preferably between 0.1 mm and 10 mm (especially between 0.1 and 1.0 mm).

It will be readily understood that, depending on the specific fields of application and on the dimensions and pressures involved, the method of implementing the invention may vary, the airtight layer then having several preferential thickness ranges.

Thus, for example, in the case of passenger vehicle tires, it may have a thickness of at least 0.4 mm, preferably between 0.8 and 2 mm. According to another example, in the case of heavy or agricultural vehicle tires, the preferred thickness may be between 1 and 3 mm. According to another example, in the case of pneumatic tires for vehicles in the civil engineering field or for aircraft, the preferred thickness may be between 2 and 10 mm.

Compared with a usual airtight layer based on butyl rubber, the airtight layer according to the invention has the advantage of exhibiting not only a lower hysteresis, and therefore of offering the pneumatic tires a reduced rolling resistance, but also an impermeability that is at least equal if not largely improved, as is demonstrated in the following exemplary embodiments.

### II. EXEMPLARY EMBODIMENTS OF THE INVENTION

The gastight layer described previously can advantageously be used in the pneumatic tires of all types of vehicles, in particular passenger vehicles or industrial vehicles such as heavy vehicles.

As an example, the single appended FIGURE shows very schematically (not drawn to scale), a radial cross section of a pneumatic tire according to the invention.

This pneumatic tire 1 has a crown 2 reinforced by a crown reinforcement or belt 6, two sidewalls 3 and two beads 4, each of these beads 4 being reinforced with a bead wire 5. The crown 2 is surmounted by a tread (not shown in this schematic FIGURE). A carcass reinforcement 7 is wound around the two bead wires 5 in each bead 4, the upturn 8 of this reinforcement 7 lying for example towards the outside of the pneumatic tire 1, which here is shown fitted onto its rim 9. The carcass reinforcement 7 consists, as is known per se, of at least one ply reinforced by cords, called “radial” cords, for example textile or metal cords, i.e. these cords are arranged practically parallel to one another and extend from one bead to the other so as to form an angle of between 80° and 90° with the circumferential mid-plane (the plane perpendicular to the rotation axis of the pneumatic tire, which is located at mid-distance of the two beads 4 and passes through the middle of the crown reinforcement 6).

The inner wall of the pneumatic tire 1 comprises an airtight layer 10, for example having a thickness equal to around 0.9 mm, on the side of the internal cavity 11 of the pneumatic tire 1.

This inner layer (or “inner liner”) covers the entire inner wall of the pneumatic tire, extending from one sidewall to the other, at least as far as the rim flange when the pneumatic tire is in the fitted position. It defines the radially internal face of said pneumatic tire intended to protect the carcass reinforcement from the diffusion of air coming from the internal space 11 of the pneumatic tire. It enables the pneumatic tire to be inflated and kept under pressure. Its airtightness properties ought to enable it to guarantee a relatively low rate of pressure loss, and to make it possible to keep the pneumatic tire inflated, in the normal operating state, for a sufficient time, normally several weeks or several months.

Unlike a conventional pneumatic tire that uses a composition based on butyl rubber, the pneumatic tire according to the invention uses, in this example, as the airtight layer 10, an elastomer composition comprising a SIBS elastomer (“Sibstar 102T” with a stirene content of around 15%, a T_{g} of around −65° C. and a Mₙ of around 90 000 g/mol) extended for example with a FIB oil (for example 55 phr of the “Dynapak Poly 190” oil—Mₙ, of around 1000 g/mol), and also more than 5% by volume of platy filler (for example 33 phr of “Iriodin 153” mica).

The pneumatic tire provided with its airtight layer (10) as described above may be produced before or after vulcanization (or curing).

In the first case (i.e., before vulcanization of the pneumatic tire), the airtight layer is simply applied in a conventional manner at the desired place, so as to form the layer 10. The vulcanization is then carried out conventionally. The TPS elastomers are well able to withstand the stresses associated with the vulcanization step.

One advantageous manufacturing variant, for a person skilled in the art of pneumatic tires, would consist for example during a first step, in laying down the airtight layer directly onto a building drum, in the form of a skim with a suitable thickness, before this is covered with the rest of the structure of the pneumatic tire, according to manufacturing techniques well known to a person skilled in the art.

In the second case (i.e. after curing of the pneumatic tire), the airtight layer is applied to the inside of the pneumatic tire cured by any appropriate means, for example by bonding, by spraying or else by extrusion and blow moulding a film of suitable thickness.

### II-1. Impermeability Tests

In the following examples, the airtightness properties were first analysed on test specimens of compositions based on butyl rubber on the one hand and on TPS elastomer on the other hand (with and without extender oil, as regards the TPS elastomer, and with platy fillers of varying natures and with varying contents).

For this analysis, a rigid-wall permeameter was used, placed in an oven (temperature of 60° C. in the present case), equipped with a relative pressure sensor (calibrated in the range of 0 to 6 bar) and connected to a tube equipped with an inflation valve. The permeameter may receive standard test specimens in disc form (for example having a diameter of 65 mm in the present case) and with a uniform thickness which may range up to 3 mm (0.5 mm in the present case). The pressure sensor is connected to a National Instruments data acquisition card (0-10 V analogue four-channel acquisition) which is connected to a computer that carries out a continuous acquisition with a frequency of 0.5 Hz (1 point every two seconds). The permeability coefficient (K) is measured from the linear regression line giving the slope α of the pressure loss through the test specimen tested as a function of the time, after a stabilization of the system, that is to say after obtaining a steady state during which the pressure decreases linearly as a function of the time.

### A) Test 1

Gastight compositions containing an SIBS elastomer (“Sibstar 102T”), a PIB oil (“Dynapak 190”) and variable amounts of platy filler (“Iriodin 153”, mica covered with titanium oxide) were prepared (platy filler introduced into TPS and PIB both previously put into solution in an organic solvent such as cyclohexane). Then they were compared to a conventional composition for an inner layer, based on butyl rubber and on carbon black (without platy filler). The impermeability was measured on test specimens according to the procedure described above.

Their formulation and their relative performance, compared to the control based on butyl rubber (composition C-1), are given in Table 1 below. The plasticizer contents are expressed in phr, those of the platy filler in phr (relative to the weight of SIBS elastomer) and also in volume % (relative to the total volume of the TPS elastomer composition).

TABLE 1

| Composition No: | C-1 | C-2 | C-3 | C-4 | C-5 | C-6 | C-7 |
|---|---|---|---|---|---|---|---|
| Butyl rubber | 100 | — | — | — | — | — | — |
| TPS elastomer (SIBS) | — | 100 | 100 | 100 | 100 | 100 | 100 |
| Oil (PIB) (phr) | — | — | 67 | 67 | 67 | 67 | 67 |
| Mica (phr) | — | — | — | 50 | 82 | 126 | 165 |
| Mica (vol %) | — | — | — | 9 | 14 | 20 | 25 |
| Relative imperme- | 100 | 100 | 53 | 140 | 197 | 309 | 505 |
| ability (%) | | | | | | | |

Only compositions C-4 to C-7 are therefore in accordance with the invention.

Firstly, it is noted that the TPS elastomer alone (composition C-2), used without platy filler or extender oil, already has a very good impermeability since it is equivalent to that of the usual composition based on butyl rubber (composition C-1). This already constitutes a remarkable result for such a material. Its modulus M10 is nearly 40% less than that of the control composition (1.4 MPa compared to 2.3 MPa).

The addition of a polybutene oil to the SIBS elastomer, intended to facilitate, as described previously, the processing and the integration of the gastight layer in the inflatable article, especially by virtue of a lowering of the modulus and an increase of the tackifying power of said composition, is however carried out at the expense of a notable loss of impermeability (loss of a factor of around two in composition C-3). It should be noted that in the presence of a conventional oil such as a paraffinic oil, this loss of impermeability was even more marked (loss of a factor of four relative to the control); it is for this reason that the combination of TPS elastomer such as SIBS and of polybutene oil such as PIB has proved to offer the best compromise of properties.

The loss of impermeability is however largely corrected in the compositions according to the invention, by virtue of the presence of the platy filler: thus, compositions C-4 to C-7 unexpectedly make it possible, even in the presence of the extender oil, to offer a level of impermeability considerably greater than that of the control composition (C-1) based on butyl rubber. It is noted, for example, that a platy filler content at least equal to around 15% or 20% by volume (typically a weight content greater than around 80 phr or 120 phr) makes it possible to increase the impermeability by at least a factor of two to three relative to the control solution.

### B) Test 2

Other elastomer compositions were prepared, containing the SIBS elastomer (“Sibstar 102T”), the PIB oil (“Dynapak 190”) and variable amounts of a platy filler of graphite type (“Timrex BNB90”); SIBS and PIB were premixed via extrusion, using a twin-screen extruder, before incorporating the platy filler into the mixture of SIBS and PIB, in an internal mixer.

Their formulation and their relative performance, compared to the control composed of a butyl rubber (composition C-8) are given in Table 2 below. The PIB oil contents are expressed in phr, those of the platy filler in phr (relative to the weight of SIBS elastomer) and also in volume % (relative to the total volume of the composition).

TABLE 2

| Composition No: | C-8 | C-9 | C-10 | C-11 | C-12 | C-13 |
|---|---|---|---|---|---|---|
| Butyl rubber | 100 | — | — | — | — | — |
| TPS elastomer (SIBS) | — | 100 | 100 | 100 | 100 | 100 |
| Oil (PIB) (phr) | — | — | 55 | 55 | 55 | 55 |
| Graphite (phr) | — | — | — | 19 | 42 | 67 |
| Graphite (% vol) | — | — | — | 5 | 10 | 15 |
| Relative imperme- | 100 | 100 | 55 | 61 | 103 | 142 |
| ability (%) | | | | | | |

Only the compositions C-12 and C-13, comprising more than 5% by volume (i.e. around more than 20 phr) of platy filler are therefore in accordance with the invention.

The results from Table 2 confirm those from the preceding Table 1, namely that the specific formulation of the compositions according to the invention (C-12 and C-13) makes it possible to achieve a level of impermeability at least equal to if not greater than that of the control composition made of butyl rubber (C-8). The composition C-11 does not make it possible to achieve a satisfactory impermeability due to a weight content of platy filler of less than 20 phr (19 phr corresponding to a volume content of 5%), which represents however a usual content for conventional compositions based on butyl rubber that comprise platy fillers.

### II-2. Pneumatic Tire Tests

Following the above laboratory tests, pneumatic tires according to the invention, of the passenger vehicle type (dimension 195165 R15) were manufactured, their inner wall being covered with an airtight layer (10) having a thickness of 0.9 mm (laid on a building drum, before manufacture of the rest of the tire). Then the tires were vulcanized. Said airtight layer (10) was formed from SIBS extended with 55 phr of PIB oil and comprising a platy filler (33 phr, i.e. around 7% by volume, of “Iriodin 153” mica).

These pneumatic tires according to the invention were compared with control pneumatic tires (Michelin “Energy 3” brand) comprising a conventional airtight layer, of the same thickness, based on butyl rubber. The impermeability of the two types of tires was measured (loss of pressure at 20° C. after 4 weeks); it was of the same level.

The rolling resistance of the pneumatic tires was measured on a flywheel, according to the ISO 8767 (1992) method. It was observed that the pneumatic tires of the invention had a rolling resistance that was reduced very significantly, and unexpectedly for a person skilled in the art, by almost 4% relative to the control pneumatic tires.

In conclusion, the invention offers the designers of pneumatic tires the opportunity of reducing the hysteresis of the airtightness inner layers very substantially, and therefore of reducing the fuel consumption of motor vehicles fitted with such tires, while providing an impermeability that is at least equal to, if not greater than that obtained with a conventional airtight layer made of butyl rubber.

1. An inflatable article equipped with a layer impermeable to inflation gases, wherein said layer comprises an elastomer composition comprising at least, as the sole elastomer or as the predominant elastomer by weight, a thermoplastic stirene elastomer (“TPS”) and a platy filler having a volume content of greater than 5% (% by volume of the elastomer composition).

2. The inflatable article according to claim 1, wherein the TPS elastomer is a copolymer with polystirene and polyisobutylene blocks.

3. The inflatable article according to claim 2, wherein the TPS elastomer is a stirene/isobutylene/stirene copolymer.

4. The inflatable article according to claim 1, wherein the TPS elastomer comprises between 5 and 50% by weight of stirene.

5. The inflatable article according to claim 1, wherein the glass transition temperature of the TPS elastomer is less than −20° C.

6. The inflatable article according to claim 1, wherein the number-average molecular weight of the TPS elastomer is between 30 000 and 500 000 g/mol.

7. The inflatable article according to claim 1, wherein the volume content of platy filler is between 5% and 50%.

8. The inflatable article according to claim 1, wherein the platy filler is chosen from the group consisting of graphites, phyllosilicates and mixtures of such fillers.

9. The inflatable article according to claim 8, wherein the platy filler is chosen from the group consisting of graphites, talcs, micas, and mixtures of such fillers.

10. The inflatable article according to claim 1, wherein the elastomer composition also comprises an extender oil for the elastomer.

11. The inflatable article according to claim 10, wherein the extender oil is chosen from the group consisting of polyolefin oils, paraffinic oils, naphthenic oils, aromatic oils, mineral oils, and mixtures of these oils.

12. The inflatable article according to claim 11, wherein the extender oil is chosen from the group consisting of polybutene oils.

13. The inflatable article according to claim 12, wherein the extender oil is a polyisobutylene oil.

14. The inflatable article according to claim 10, wherein the number-average molecular weight of the extender oil is between 200 and 25 000 g/mol.

15. The inflatable article according to claim 10, wherein the content of extender oil is greater than 5 phr (parts by weight per hundred parts of elastomer).

16. The inflatable article according to claim 15, wherein the content of extender oil is between 5 phr and 100 phr.

17. The inflatable article according to claim 1, wherein the gastight layer has a thickness greater than 0.05 mm.

18. The inflatable article according to claim 17, wherein the gastight layer has a thickness between 0.1 mm and 10 mm.

19. The inflatable article according to claim 1, wherein the gastight layer is placed on the inner wall of the inflatable article.

20. The inflatable article according to claim 1, wherein said article is made of rubber.

21. The inflatable article according to claim 20, wherein said rubber article is a pneumatic tire.

22. The inflatable article according to claim 1, wherein said inflatable article is an inner tube.

23. The inflatable article according to claim 22, wherein said inner tube is a pneumatic tire inner tube.
